(19) United States
(12) Patent Application Publication
(10) Pub. No.: US 2007/0209752 A1
(43) Pub. Date: Sep. 13, 2007

(54) Method and device for feeding a cover

(76) Inventors: Dirk Rygol, Osnabruck (DE); Christoph von Freden, Schwaforden (DE); Andreas Walther, Stadthagen (DE)

Correspondence Address: ALIX YALE & RISTAS;SUITE 600, 750 MAIN STREET, HARTFORD, CT, 06103, US

(21) Appl. No.: 11/716,480

(22) Filed: Mar. 9, 2007

(30) Foreign Application Priority Data
Mar. 13, 2006 (DE) DE 102006011430.2

(51) Int. Cl. B32B 38/04; B32B 37/00; B32B 38/14

(52) U.S. Cl. 156/209; 156/256; 156/277; 156/216; 156/252; 156/269; 156/267; 156/227; 156/521; 156/387; 156/513; 156/459; 156/461

(57) ABSTRACT

A method and apparatus for feeding a cover (10, 11, 12, 13) in the production of perfect-bound or saddle-stitched books, brochures, magazines or similar printed products (14, 15) featuring an inner part (2) that consists of a collection of folded sections, layers and/or individual sheets and a cover (10, 11, 12, 13) that is placed around the inner part (2) and connected thereto. A roll (3) comprising a wound-up cover web (4) is supplied, the cover web (4) is unwound and a cover sheet (10, 11, 12, 13) with the desired format height is separated from the cover web (4, 8) and fed to the inner part (2) in order to be placed around the inner part and connected thereto. This allows a reliable and flawless feed of the covers to the inner parts, and the operating effort for the cover feed is reduced.

### BACKGROUND

The present invention pertains to a method and a device for feeding a cover in the production of perfect-bound or saddle-stitched books, brochures, magazines or similar printed products featuring an inner part that consists of a collection of folded sections, layers and/or individual sheets and a cover that is placed around the inner part and connected thereto.

In an adhesive binder for producing perfect-bound books, brochures or magazines, gathered sheets or folded sections are transported in book block clamps of a transport system with a defined overhang and connected into a book block or brochure block by applying an adhesive on the processed block spine. The book or brochure block is connected to a scored cover by means of a cover attachment and press-on device, in which the cover is pressed against the block spine as well as adjacent lateral regions during the continuous movement of the book or brochure block.

Gather-stitcher machines are used for producing magazines and journals that are saddle-stitched with wire. Gathered folded sections that are placed inside one another and a cover are positively connected from the outside toward the inside by means of wire staples extending through the spine. The cover is previously fed to the collection of folded sections by means of a cover folder/feeder, in which the cover is folded and placed on a gathering chain transporting the collection of folded sections in a synchronous cycle.

Depending on the supply or stocking of the covers, cover feed devices may be realized in the form of flat stack feeders, vertical sheet feeders or stream feeders. One common aspect of all variations is that stacks of covers need to be manually loaded into the magazines or on a stream feed conveyor. Considerable skill and experience in handling large-surface cover sheets are required for an efficient and flawless loading process. In high-performance adhesive binders and gather-stitcher machines, one worker is usually required just for loading the cover feed device.

During the decollating of the covers in the cover feed device, it sometimes occurs that a cover is incorrectly pulled off or that two covers are pulled off. This problem arises more frequently when processing special covers, e.g., covers with folded-in flaps, supplements glued thereon, perforations or punched-out sections or covers that are composed of two end sheets that are flatly glued to one another by means of a lining strip, so-called combined end sheets. This is often caused by shifted covers or covers that adhere to one another. The repair of such malfunctions and thusly induced dependent malfunctions at other locations of the adhesive binder or gather-stitcher machine is very time-consuming and reduces the net output of the adhesive binder or gather-stitcher machine.

Another disadvantage can be seen in that covers cut to the desired format on guillotine cutters may deviate with respect to their dimensions and angles such that the cover is not correctly positioned relative to the book block on the finished product.

### SUMMARY

The present invention is directed to a method for feeding a cover in the production of perfect-bound or saddle-stitched books, brochures, magazines or similar printed products featuring an inner part that consists of a collection of folded sections, layers and/or individual sheets and a cover that is placed around the inner part and connected thereto, as well as a device for carrying out this method, for reliably and flawlessly feeding the covers to the inner parts with only little operating effort.

According to the present disclosure, this objective is achieved in a surprisingly effective manner, in that a roll of a wound-up cover web is supplied, in that the cover web is unwound, and in that a cover sheet of the desired format height is separated from the cover web and fed to the inner part in order to be placed around the inner part and connected thereto. The individual cover sheet is only separated from the cover web shortly before it is combined with the inner part. The separation process is functionally much safer and less detrimental to the product than the decollating of the covers from a feed stack such that significantly fewer malfunctions occur, e.g., due to missing covers or double covers in the cover feed.

This eliminates the need to manually load the magazines or stream feed conveyors with stacks of large-surface covers that are difficult to handle. Furthermore, a roll is able to accommodate a much larger number of covers than a stack such that their handling and supply to the cover feed device is additionally simplified and it is no longer necessary to assign a separate operator to the cover feed device.

The cutting of the covers in the guillotine cutter is also eliminated. The covers can be produced in a highly accurate fashion in the adhesive binder during the feed of the covers. The production, handling and intermediate storage of the wound-up cover web also results in reduced expenditures.

According to one preferred embodiment of the method, the cover web is printed after it is unwound. Particularly simple covers, e.g., single-color covers, can be quickly and cost-efficiently produced with the desired contents without a separate printing machine. However, the method also makes it possible, in principle, to directly manufacture covers that have a complex design and are printed with multiple colors on the adhesive binder.

Additional preferred features are based on the concept that the further processing and finishing steps can be carried out much more reliably and less detrimentally to the product on the endless cover web than on individual cover sheets.

In yet another preferred feature, so-called combined end sheets are separated from a combined end sheet web shortly before they are combined with the book block.

The separation of the cover sheet can take place shortly before it is combined with the inner part. The separated cover sheets are directly fed to the combining point over a relatively short transport distance.

The separated cover sheets are advantageously buffered in a magazine. The number of buffered cover sheets can be maintained so low that the cover sheets can be decollated much more reliably than with the magazines of conventional cover feed devices according to the state of the art. The buffering makes it possible to continuously and uniformly unwind the cover web regardless of possibly occurring fluctuations in the output of the adhesive binder or gather-stitcher machine.

The inventive method can be implemented in an adhesive binder and in a gather-stitcher machine.

An apparatus embodiment for carrying out the method features an unwinding device for unwinding a cover web from a roll, arranged upstream of a cover attachment device, as well as a cross cutter for separating a cover sheet from the cover web. Unwinding devices and cross cutters are customary devices used in the processing of paper webs and operate in a highly reliable fashion due to their simple functional principle.

### BRIEF DESCRIPTION OF THE DRAWING

The invention is disclosed in greater detail in the following description of the preferred embodiments and accompanying drawing, in which the figures contain simplified partial perspective representations:

FIG. 1 shows an adhesive binder with a cover feed for the production of a simple brochure with a cover that is scored twofold or fourfold;

FIG. 2 shows an adhesive binder with a cover feed for the production of lay-flat brochures with advertising cards glued to the inside of the cover;

FIG. 3 shows an adhesive binder with a cover feed for the production of perfect-bound book blocks by means of combined end sheets, and

FIG. 4 shows an adhesive binder with a cover feed for the production of brochures with folded-in cover flaps.

### DETAILED DESCRIPTION

The figures respectively show a partial view of an adhesive binder 1 that features a transport system 16 with a multitude of the book block clamps 17 that can be continuously moved along a closed oval loop and are interconnected with respect to their drive. The adhesive binder features an infeed path for supplying the book blocks of gathered folded sections to the book block clamps 17 and a delivery path for delivering the perfect-bound brochures 14 or book blocks 15.

Devices for processing 18 the spine, gluing 19 the spine and gluing 20 the sides of the book block 2 are arranged along a first straight section of the transport system 16. A cover feed 23a, b, c or d and at least one cover press-on device 24 for pressing the cover 10, 11, 12 or 13 against the glued spine of the book block 2 are situated along a second straight transport section aligned with the delivery path.

The cover feed 23a, b, c or d features an unwinding device 30 for unwinding a continuous cover web 4, which is pulled off a cover roll 3 accommodated in the unwinding device 30 by means of a pair of pull-off rollers 31. A cross cutter 35 is arranged directly downstream of the pair of pull-off rollers in order to cut and thereby separate a cover 10, 11, 12 or 13 having the desired format height from the cover web 4.

The separated cover 10, 11, 12 or 13 is transferred to a cover conveyor 21 that preferably consists of two parallel conveying belts 21a with pushers 21b arranged adjacent to one another and is transported by this cover conveyor to a pressing roller 22 that presses the cover 10, 11, 12 or 13 against the book block spine. It would also be possible to utilize a contact table instead of the pressing roller 22. The cover press-on device 24 presses the cover 10, 11, 12 or 13 against the book block spine from the bottom and the sides by means of revolving pressing rails and is situated directly downstream of the pressing roller 22.

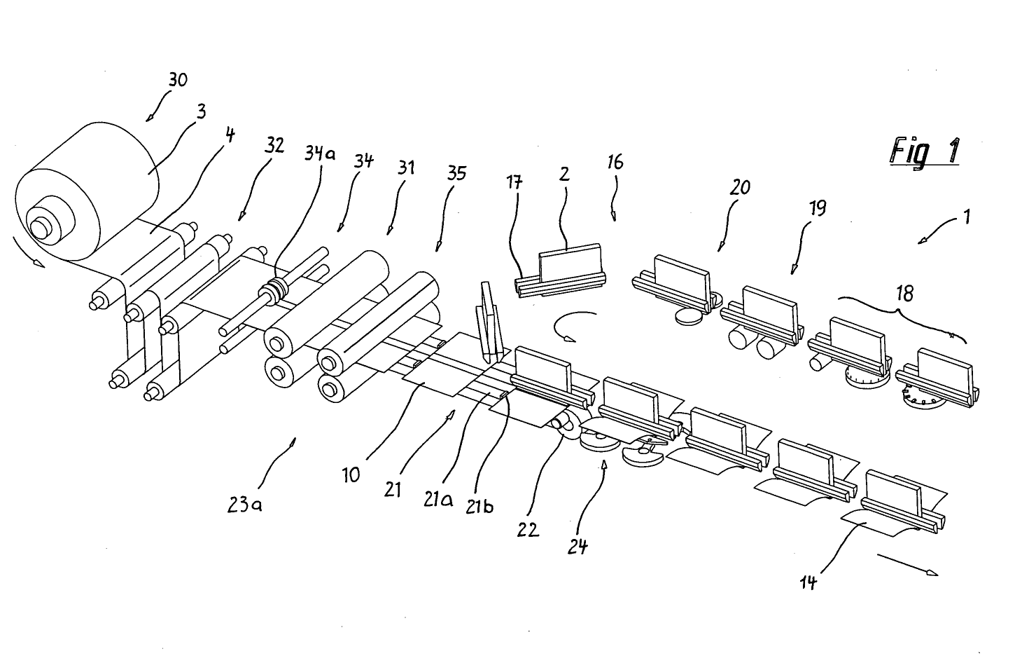

A first embodiment 23a of the cover feed is shown in FIG. 1 and features a compensating roller system 32 and the scoring device 34 with rotative scoring tools 34a in addition to the unwinding device 30, the pair of pull-off rollers 31 and the cross cutter 35. This embodiment makes it possible to produce and supply simple covers 10 as well as covers that are scored twofold or fourfold.

The scoring of the covers is carried out on the quasi-endless cover web 4, wherein the compensating roller system 34 ensures a continuous transport of the cover web 4 regardless of possibly occurring fluctuations in the output of the adhesive binder. The scoring of the covers can be realized with high quality and is not detrimental to the product due to the fact that individual covers are no longer introduced into the scoring tools with their leading edge.

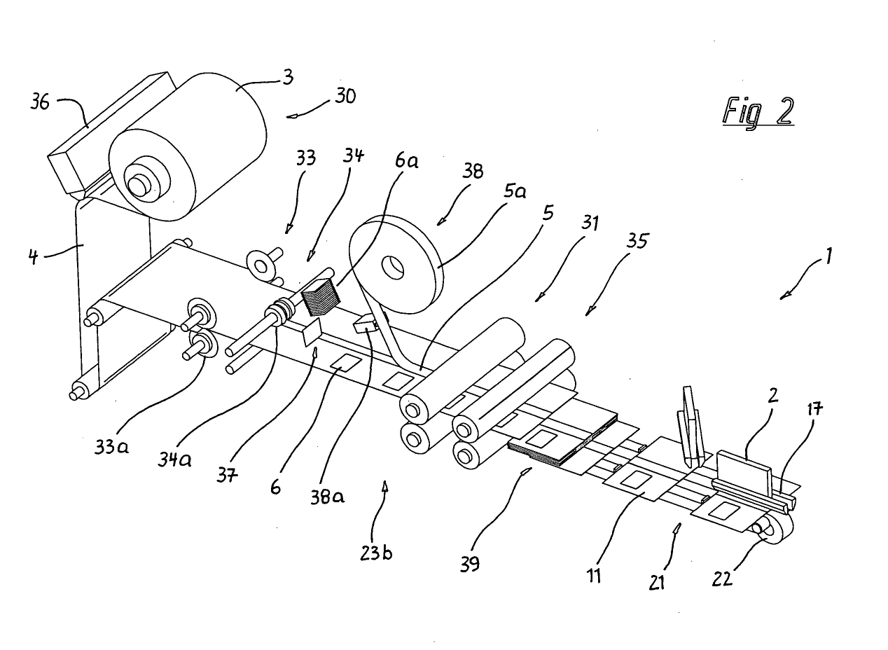

A second embodiment 23b of the cover feed is illustrated in FIG. 2 and features a printing device in the form of the print head 36, a trimming device 33 or devices with rotary knives 33a for trimming along at least one longitudinal edge, a supplement glue-on device in the form of a card gluer 37 and a lining device 38 in addition to the scoring device 34. The cover feed 23b makes it possible to produce and supply covers 11 with lining strips 5 glued to the inside in the region of the spine and supplements such as advertising cards 6 glued to the inside of one cover page, e.g., for producing lay-flat brochures.

The lining strip 5 is unwound from a lining roll 5a in the lining device 38 that is not illustrated in greater detail, provided with glue from a glue nozzle 38a and glued on the cover web 4. The card gluer 37 that is also not illustrated in greater detail removes the advertising cart 6 from a stack 6a and places the advertising card that is provided with a track of glue on the cover web 4 within defined distances that correspond to the subsequent cover height.

The longitudinal trimming device 33 makes it possible to trim neutral cover webs 4 delivered in specific widths to the respective width of the open cover required for the brochure. Such a neutral cover web 4 can be printed with information related to the brochure being produced by means of the printing station 36.

In order to make it possible to continuously and uniformly unwind the cover web 4 regardless of possibly occurring fluctuations in the output of the adhesive binder, the cover feed 23b is equipped with a buffer magazine 39, into which the covers 11 separated by the cross cutter 36 are placed. Since only a limited quantity of covers 11 needs to be intermediately stored, the stack of covers only has a small height and therefore only exerts a slight load such that the covers 11 are not shifted and/or do not adhere to one another and thusly impair the reliable decollating of the covers 11 from the buffer magazine 39.

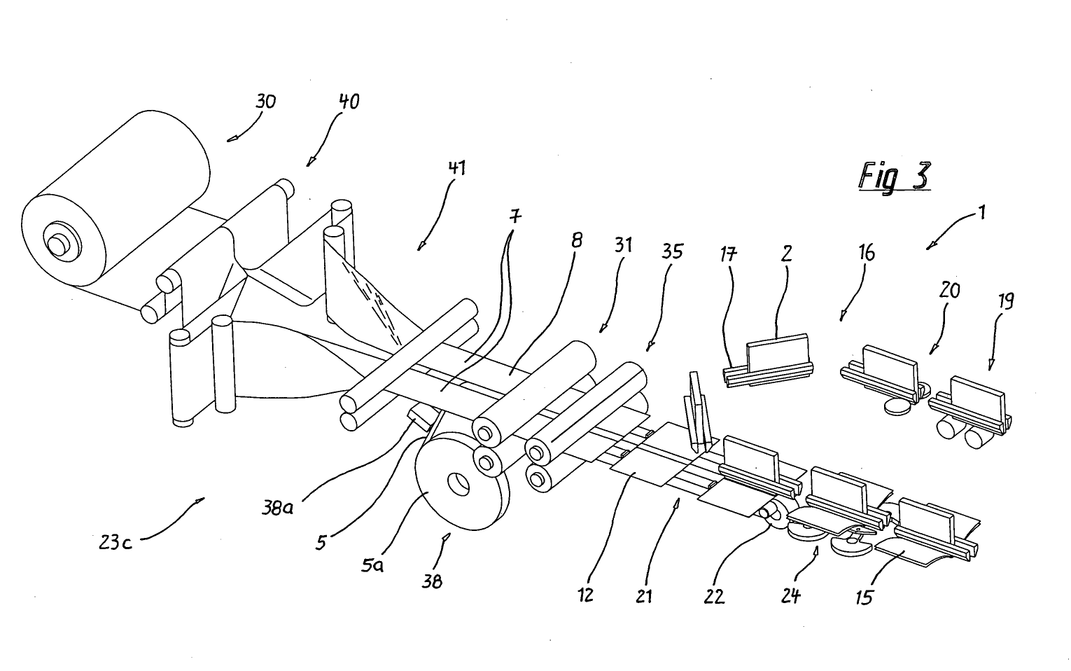

FIG. 3 shows a third embodiment 23c of a cover feed. This embodiment makes it possible to produce and supply so-called combined end sheets 12 that consist of two end sheets that are arranged parallel to one another and flatly glued by means of a lining strip 5 in order to produce lined book blocks 15 provided with end sheets.

The end sheets are folded apart and unwound in the unwinding device 30 in the form of a doublewide web that is subsequently divided into two partial webs by means of a longitudinal splitter 40. The partial webs are folded into end sheet webs 7 by means of a web folding device 41. A lining device 38 arranged underneath the web flatly glues the two end sheet webs 7 that lie at a defined distance from one another into a combined end sheets web 8, from which combined end sheets 12 with the desired format height can subsequently be separated with the cross cutter 35.

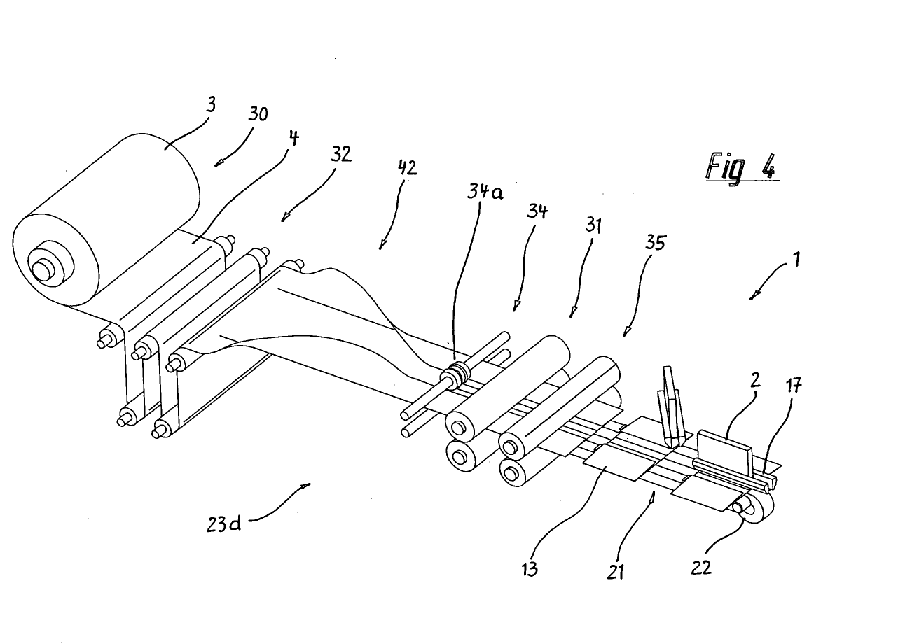

A fourth embodiment 23d of the cover feed is illustrated in FIG. 4. In comparison with the first embodiment 23a illustrated in FIG. 1, it also features a flap scoring and fold-in device 42 and makes it possible to produce and supply flap-type covers 13, in which the cover flaps are folded in. The endless scoring of the flap joint and the folding of the cover flaps on the endless cover web 4 are particularly advantageous in this case.

The described embodiments of the invention pertain to the cover feed 23a, b, c, d in an adhesive binder. It is expressly noted that the inventive method can also be used in gather-stitcher machines, wherein the spine joint of the cover is produced with a simple scoring device arranged upstream of the cross cutter and the cover pages can be folded over downward after the separation of the cover.

It should also be understood that the term “bound printed product” as used herein, means perfect-bound or saddle-stitched books, brochures, magazines or a similar printed product (14, 15) featuring an inner part (2) that consists of a collection of folded sections, layers and/or individual sheets and a cover (10, 11, 12, 13) that is placed around the inner part (2) and connected thereto.

1. A method for feeding a cover with a desired format height in the production of bound printed products having an inner part and a cover that is placed around the inner part and connected thereto, comprising:
providing a roll of a wound-up cover web;
unwinding the cover web;
separating a cover sheet with the desired format height from the cover web;
feeding the separated cover sheet to the inner part; and
placing the cover sheet around the inner part and connecting the cover sheet thereto.

2. The method according to claim 1, wherein the cover web is printed after it is unwound.

3. The method according to claim 1, wherein the unwound cover web is selectively pre-treated by means of at least one of coating, scoring, embossing, punching and/or perforating.

4. The method according to claim 1, wherein the cover has a desired width and the unwound cover web is reduced to the desired cover width by trimming the cover web along at least one longitudinal edge.

5. The method according to claim 1, wherein a supplement is applied on the unwound cover web.

6. The method according to claim 1, wherein a lining strip is glued along the unwound cover web.

7. The method according to claim 1, wherein cover flaps are folded in on one or both sides of the unwound cover web.

8. The method according to claim 1, wherein
the cover web consists of two material webs that are unwound parallel to one another;
both webs are folded; and
the two webs are flatly glued into a combined end sheet web with a lining strip while their folded edges face one another at a defined distance from one another.

9. The method according to claim 1, wherein the cover sheet is separated from the cover web shortly before it is combined with the inner part.

10. The method according to claim 1, wherein
the cover sheets are separated from the cover web and fed to a buffer magazine in order to be intermediately stored; and
a cover sheet is decollated from the magazine and fed to the inner part.

11. The method according to claim 1, wherein the method is performed in an adhesive binder for producing perfect-bound book blocks, brochures or magazines.

12. The method according to one of claim 1, wherein the method is performed in a gather-stitcher machine and the cover sheet is essentially folded centrally after separation from the cover web.

13. Apparatus for producing bound printed products having an inner part and a cover, comprising:
a transport device for the inner part;
a cover feed device for supplying the covers in a synchronous cycle with and placing each cover around an inner part;
a roll of a wound-up cover web;
an unwinding device between the roll and the feed device, for unwinding the cover web from the roll; and
a cross cutter between the unwinding device and the feed device, for separating a cover sheet from the cover web for delivery to the feed device.

14. Apparatus according to claim 13, including a printing device arranged downstream of the unwinding device for printing the cover web on at least one side.

15. Apparatus according to claim 13, including a processing station arranged downstream of the unwinding device for performing at least one of coating, scoring, embossing, punching and/or perforating the cover web.

16. Apparatus according to claim 13, including a longitudinal trimming device arranged downstream of the unwinding device for trimming along at least one longitudinal edge of the cover web.

17. Apparatus according to claim 13, including a supplement glue-on station arranged downstream of the unwinding device for applying supplements on the cover web.

18. Apparatus according to claim 13, including a lining device arranged downstream of the unwinding device for gluing a lining strip on the cover web.

19. Apparatus according to claim 13, including a flap scoring and fold-in device arranged downstream of the unwinding device for producing folded-in cover flaps on at least one side of the cover web.

20. Apparatus according to claim 13, including
a web splitter for dividing two parallel cover web portions that lie adjacent to one another;
folding devices for folding the web portions; and
a lining device for flatly gluing the two web portions into a combined end sheet web with a lining strip.

21. Apparatus according to claim 13, including a magazine buffer for the cover sheets arranged between the cross cutter and the cover feed device.

22. Apparatus according to claim 13, wherein the unwinding device, the cross cutter and the cover feed device are arranged on an adhesive binder with a transport device comprising a multitude of book block grippers that can be continuously moved along a closed loop and are interconnected with respect to their drive.
